(19) United States
(12) Patent Application Publication
(10) Pub. No.: US 2026/0064802 A1
(43) Pub. Date: Mar. 5, 2026

(54) METHOD AND SYSTEM TO SUPPORT KERNEL DIVISION FOR TRANSPOSED CONVOLUTION FOR MACHINE LEARNING

(71) Applicant: Marvell Asia Pte Ltd, Singapore (SG)

(72) Inventors: Harri Hakkarainen, Los Gatos, CA (US); Sebastian Lesniak, Krakow (PL); Adam Latos, Krakow (PL); Przemyslaw Baranski, Lodz (PL); Veena Karthikeyan, Los Gatos, CA (US)

(21) Appl. No.: 18/958,983

(22) Filed: Nov. 25, 2024

Related U.S. Application Data
(63) Continuation of application No. 18/958,862, filed on Nov. 25, 2024.
(60) Provisional application No. 63/688,180, filed on Aug. 28, 2024.

(51) Int. Cl. G06F 17/15

(52) U.S. Cl. CPC G06F 17/15

(57) ABSTRACT

A new approach is proposed that contemplates system and method to support efficient implementation of transposed convolution for machine learning (ML). Under the proposed approach, input data/tensor to a transposed convolution operation is optimized before the transposed convolution operation and each of a plurality of original kernels used for the transposed convolution operation is divided into a plurality of smaller sub-kernels. A plurality of direct sub-convolutions are then performed by sequentially applying each sub-kernel of the plurality of sub-kernels of each of the original kernels over the optimized input tensor without flattening either the input tensor or the plurality of sub-kernels. The output from the sub-convolutions using the plurality of sub-kernels are then combined as the final output tensor for each of the original kernels for the transposed convolution operation.

### RELATED APPLICATION

This application is a continuation application of U.S. patent application Ser. No. 18/958,862, filed Nov. 25, 2024, which claims the benefit and priority to a provisional application No. 63/688,180 that was filed on Aug. 28, 2024, which is incorporated herein by reference in its entirety.

### BACKGROUND

Transposed convolution, also referred to as deconvolution or up-sampling, is a mathematical operation specifically used in machine learning (ML) architectures such as Convolutional Neural Networks (CNNs). The primary purpose of transposed convolution is to upscale/up-sample or increase spatial dimensions (i.e., height and width) of an input data, and is often used in tasks such as image reconstruction, segmentation, or generative models such as generative adversarial networks (GANs) for ML operations. In one instance, transposed convolution increases size of the input data by padding the input data with zeros and inserting additional row and/or columns of zeros into the input data, applying a regular convolution operation by sliding a kernel or filter over the input data, and outputting a larger (up-sampled) feature map. Note that transposed convolution does not reverse a standard convolution by values.

The zero-padding and insertion of the additional rows and columns of zeros in the input data result in a sparse input tensor. Consequently, current transposed convolution solutions suffer from reduced matrix multiplication efficiency during the convolution operation as the kernel sliding over the sparse input tensor consisting of a large number (e.g., 30-70%) of zeros. There is no mathematical benefit from multiplying and accumulating these zeros and it leads to low computational efficiency. Flattening the input data and the kernels into linearly-stored non-zero data to get rid of the zeros before the matrix multiplication, on the other hand, is very time-consuming and leaves a large memory footprint.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system 100 to support efficient implementation of transposed convolution according to one aspect of the present embodiments.

FIG. 2 depicts an example of various steps of a transposed convolution operation.

FIG. 3A depicts an example of the padded input data of size [15, 47, 512] following insertion of rows and columns of zeros and zero padding, wherein white elements represent the original input tensor and gray elements represent rows and columns and number of zeros inserted according to one aspect of the present embodiments.

FIG. 3B depicts an example of the padded input tensor without the rows and columns of zeros inserted based on the set of new padding parameters according to one aspect of the present embodiments.

FIG. 3C depicts an example of a 6×6 original kernel and FIG. 3D depicts examples of four sub-kernels generated from the original kernel in the height and width directions, respectively, according to one aspect of the present embodiments.

FIG. 3E depicts an example of the first two steps of a convolution operation on the unoptimized input tensor padded under the conventional padding parameters as shown in FIG. 3A in the width direction using the original kernel of FIG. 3C; FIG. 3F depicts an example of the first two steps of a convolution operation on the optimized input tensor padded under the new set of padding parameters as shown in FIG. 3B in the width direction using two different sub-kernels [0, 0] and [0, 1] as shown in FIG. 3D, respectively, according to one aspect of the present embodiments.

FIG. 3G depicts an example of combining outputs of a plurality of sub-convolutions of each of the plurality of output channels according to one aspect of the present embodiments.

FIG. 4 depicts a flowchart of an example of a process to support efficient implementation of transposed convolution according to one aspect of the present embodiments.

FIG. 5 is a block diagram illustrating an example of a computing system/device 500 used to implement the system 100 to support efficient implementation of transposed convolution according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is proposed that contemplates system and method to support efficient implementation of transposed convolution for machine learning (ML). Under the proposed approach, input data/tensor to a transposed convolution operation is optimized (e.g., compressed) before the transposed convolution operation and each of a plurality of original kernels used for the transposed convolution operation is divided into a plurality of smaller sub-kernels. A direct convolution operator then performs a plurality of sub-convolutions by sequentially applying each of the plurality of sub-kernels of each of the original kernels over the optimized input data. The output from the sub-convolutions using the plurality of sub-kernels are then combined as the final output tensor for each of the original kernels for the transposed convolution operation.

By reducing zero padding and skipping insertion of rows and columns of zeros in the input data, the proposed approach optimizes the input data to avoid multiplications by zeros during convolution. As a result, the proposed approach significantly improves the matrix multiplication efficiency (e.g., lower latency and higher throughput) during the transposed convolution operation. For example, depending on the user-specified convolution parameters, e.g., stride, padding size, etc., the matrix multiplication efficiency can be improved by anywhere between 30-70%. Furthermore, the use of direct convolution operator eliminates the need for flattening for matrix multiplication and thus reduces memory footprint of the transposed convolution operation for more efficient machine learning operations.

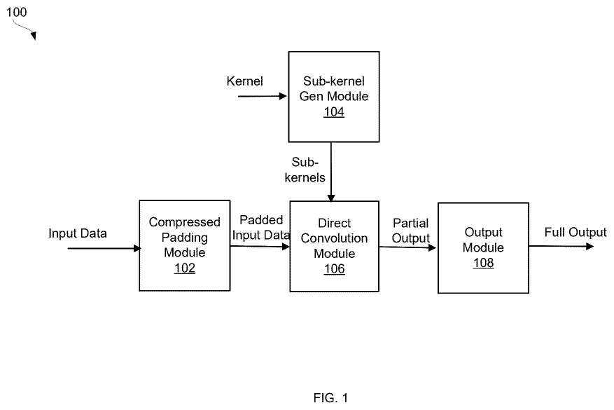

FIG. 1 depicts an example of a diagram of a system 100 to support efficient implementation of transposed convolution. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

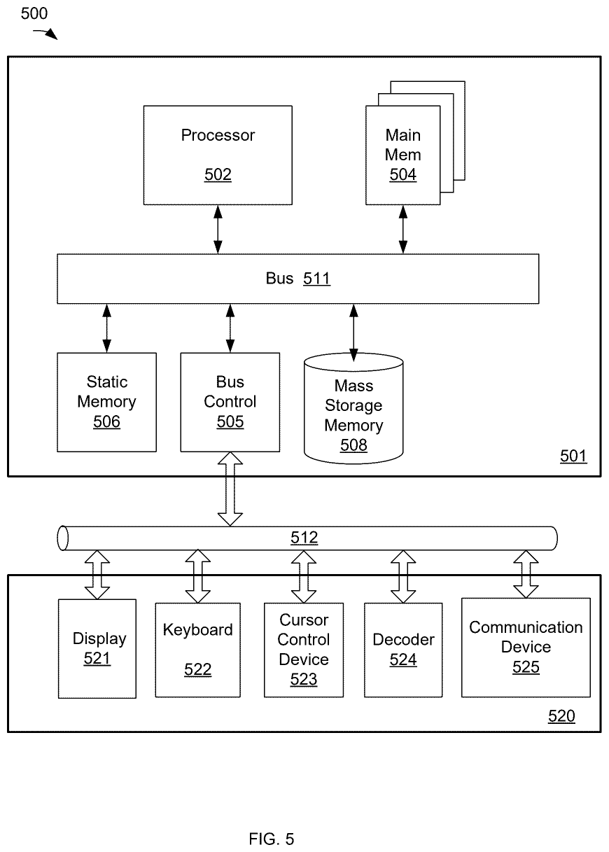

In the example of FIG. 1, the system 100 includes one or more of a compressed padding module 102, a sub-kernel generation module 104, a direct convolution module 106, and an output module 108. It is appreciated that each of the modules of the system 100 may run on one or more computing units or devices (as shown by the example of FIG. 5) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

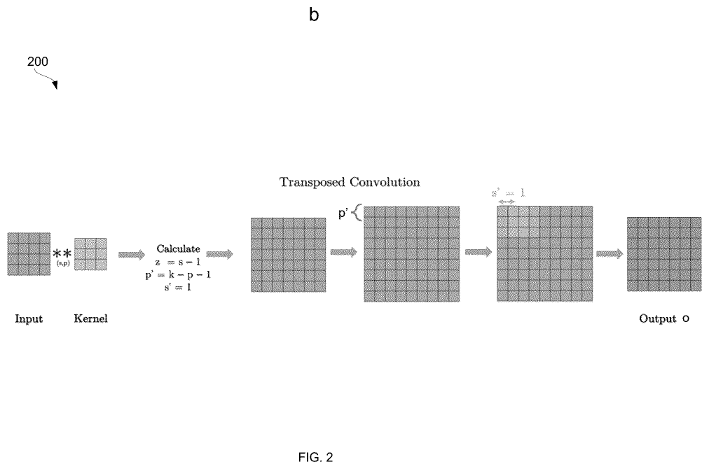

FIG. 2 depicts an example of various steps of a transposed convolution operation 200. As shown by the example of FIG. 2, the transposed convolution operation takes an input data of size i (in both the height and the width directions) and a kernel of size k as its inputs, and generates an output (e.g., feature map) having a spatial dimension greater than that of the input data. Like a standard convolutional operation, the transposed convolution operation is also defined by a padding number p and a stride s, both are specified by a user. In some embodiments, for a given size of the input data (i), kernel (k), padding (p), and stride (s), the transposed convolution operation can be implemented as a four step process as shown in FIG. 2:

Step 1: Calculate parameters z=s−1 and p′=k−p−1, wherein z denotes number of rows and columns of zeros need/supposed to be inserted between the rows and columns of the input data and p′ is an original padding number denoting number of zeros to be padded around four sides of the input data.
Step 2: Insert a row of zeros between each two existing rows and a column of zeros between each two existing columns of the input data for total of z inserted rows and columns of zeros in the input data, which increases the size of the input data to (s·(i−1)+1)×(s·(i−1)+1).
Step 3: Pad the modified input data with additional p′ number of zeros on each side of the modified input data.
Step 4: Carry out a convolution operation on the padded input data generated from the previous steps with a stride length s′=1 to generate the output feature map o.

Although the examples of the input data and the kernel as shown in FIG. 2 are both square in size, in general, the input data can be in the form of a multi-dimensional input tensor i(H, W, C), where H and W represent height and width of the input tensor, respectively, and C represents number of input channels on which the transposed convolution operation is to be performed. Accordingly, each kernel and each stride can be represented by k(H, W) and s(H, W) in the height and width directions, respectively, while the padding parameters on four sides of the input tensor can be represented by p(top, left, bottom, right). The output tensor can be represented by o(H, W, N), where N is the number of kernels being used during the transposed convolution operation, which also equals to the number of output channels.

A non-limiting example having the following parameters is used to illustrate the transposed convolution operation above:

$$i ( H , W , C ) = ( 5 , 21 , 512 ) ; \\ k ( H , W ) = ( 6 , 6 ) ; \\ s ( H , W ) = ( 2 , 2 ) ; and \\ p ( top , left , bottom , right ) = ( 2 , 2 , 2 , 2 ) .$$

Based on these parameters, the transposed convolution operation parameters z(H, W) in the height and width directions, and the set of original padding parameters p′(left, bottom, right) on four sides of the input tensor can be calculated under Step 1 above as follows:

$$z ( H , W ) = s ( H , W ) - 1 = ( 1 , 1 ) ; \\ {p}^{′} ( top ) = k ( H ) - p ( top ) - 1 = 3 ; \\ {p}^{′} ( left ) = k ( W ) - p ( left ) - 1 = 3 ; \\ {p}^{′} ( bottom ) = k ( W ) - p ( bottom ) - 1 = 3 ; \\ {p}^{′} ( right ) = k ( W ) - p ( right ) - 1 = 3 ; \\ with {s}^{′} = 1.$$

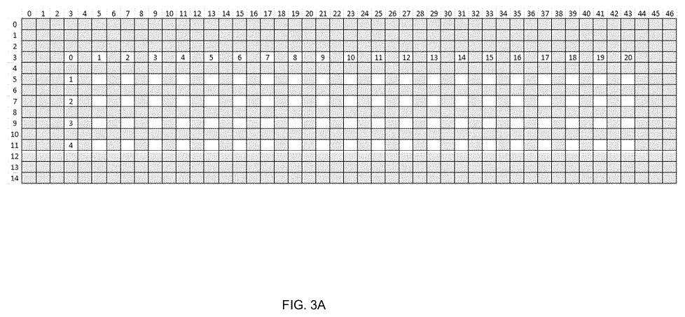

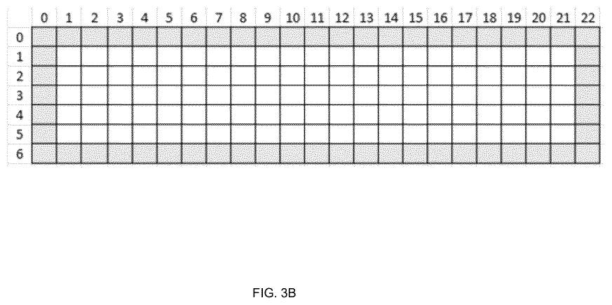

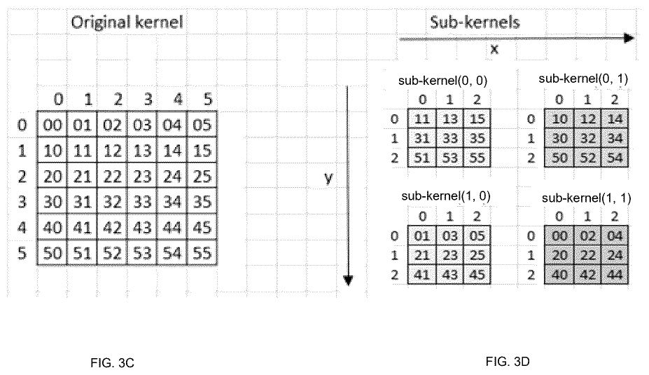

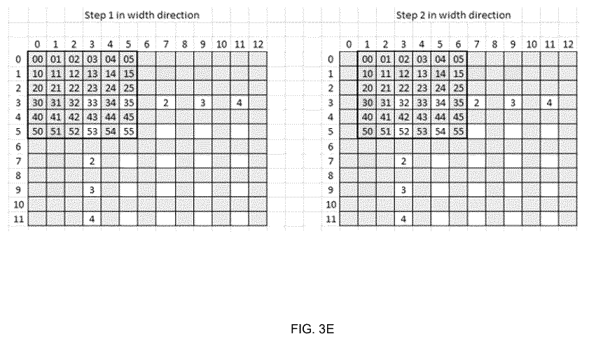

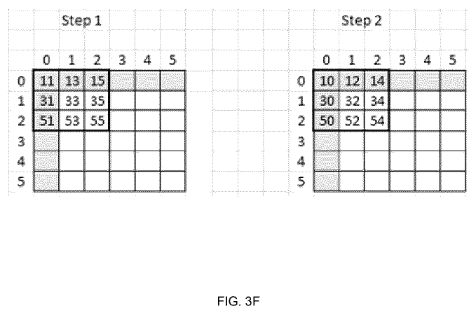

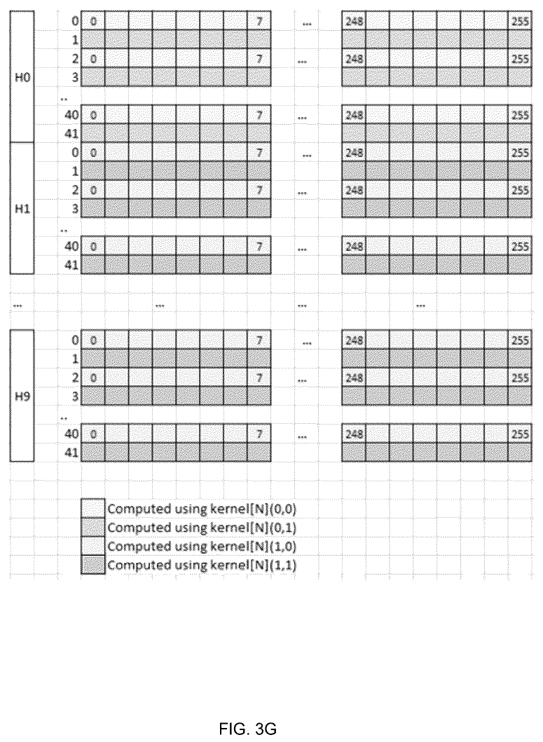

FIG. 3A depicts an example of one of the 512 input channels of the padded input tensor of size pi(H, W)=(15, 47) following Steps 2 and 3 above, wherein white elements in FIG. 3A represent the original input tensor i and gray elements in FIG. 3A represent inserted z rows and columns and p′ number of inserted zeros. 256 6×6 transpose kernels corresponding to 256 output channels are convolved over the padded input tensor at Step 4 above to generate an output tensor o of the following dimensions o(H, W, N)=(10, 42, 256), wherein:

$$o ( H ) = Ysteps ( i . e . , vertical 6 \times 6 kernel steps ) = ( pi ( H ) - ( k ( H ) - {s}^{′} ) ) / {s}^{′} = ( 15 - ( 6 - 1 ) ) / 1 = 10 ; \\ o ( W ) = Xsteps ( i . e . , horizontal 6 \times 6 kernel steps ) = ( pi ( H ) - ( k ( W ) - {s}^{′} ) ) / {s}^{′} = ( 47 - ( 6 - 1 ) ) / 1 = 42 ;$$

$$o ( N ) = 256 .$$

In the example of FIG. 1, the compressed padding module 102 is configured to accept an input tensor and optimize/compress/reduce the number of zeros need to be padded into the input tensor for a transposed convolution operation. In some embodiments, the compressed padding module 102 is configured to derive a set of new padding parameters, e.g., p″, based on the original/user-specified padding number p and numbers of rows and columns z need/supposed to be inserted during the transposed convolution operation. Specifically, in some embodiments, the set of new padding parameters p″ for the top, left, bottom and right sides/edges of the input tensor can be calculated as follows:

$${p}^{″} ( top ) = floor ( {p}^{′} ( top ) / ( z ( H ) + 1 ) ) = floor ( 3 / ( 1 + 1 ) ) = 1 ; \\ {p}^{″} ( left ) = floor ( {p}^{′} ( left ) / ( z ( W ) + 1 ) ) = floor ( 3 / ( 1 + 1 ) ) = 1 ; \\ {p}^{″} ( bottom ) = floor ( {p}^{′} ( bottom ) / ( z ( H ) + 1 ) ) = floor ( 3 / ( 1 + 1 ) ) = 1 ; \\ {p}^{″} ( right ) = floor ( {p}^{′} ( right ) / ( z ( W ) + 1 ) ) = floor ( 3 / ( 1 + 1 ) ) = 1.$$

where p′(top|left|bottom|right) is computed as p′=k−p−1 according to the kernel size k and the user-specified padding number p, and z(H) and z(W) are the numbers of zero rows and columns need/supposed to be inserted in the height and width directions/dimensions of the input tensor, respectively. Since the new padding parameter p″ is calculated by dividing the original padding number p′ by the number of rows and columns need/supposed to be inserted into the input tensor, p″ is greatly reduced from p′ as shown by the example below.

For the non-limiting example discussed above, the set of new padding parameters p″(top|left|bottom|right) can be computed as follows:

$${p}^{″} ( top ) = floor ( {p}^{′} ( top ) / ( z ( H ) + 1 ) ) = floor ( 3 / ( 1 + 1 ) ) = 1 ; \\ {p}^{″} ( left ) = floor ( {p}^{′} ( left ) / ( z ( W ) + 1 ) ) = floor ( 3 / ( 1 + 1 ) ) = 1 ; \\ {p}^{″} ( bottom ) = floor ( {p}^{′} ( bottom ) / ( z ( H ) + 1 ) ) = floor ( 3 / ( 1 + 1 ) ) = 1 ; \\ {p}^{″} ( right ) = floor ( {p}^{′} ( right ) / ( z ( W ) + 1 ) ) = floor ( 3 / ( 1 + 1 ) ) = 1 .$$

Compared to p′(top|left|bottom|right)=(3, 3, 3, 3) calculated above, the number of zeros need to be padded in the input tensor according to p″(top|left|bottom|right)=(1, 1, 1, 1) is optimized/compressed significantly.

Once the set of new padding parameters p″ has been computed, the compressed padding module 102 is configured to pad the input tensor with the set of new padding parameters p″ of zeros, e.g., expanding the input tensor on top, left, bottom, and right sides. Furthermore, the compressed padding module 102 is configured to do such padding without inserting any rows and/or columns of zeros into the input tensor, thus reducing the total number of zeros inserted into the padded input tensor. FIG. 3B depicts an example of an optimized padded input tensor (without the z rows and columns of zeros inserted) based on the set of new padding parameters p″. Compared to the example of the unoptimized padded input tensor of size (15, 47) as shown in FIG. 3A, size of the example of the padded input tensor as shown in FIG. 3B is reduced to (7, 23). By reducing the padding of zeros (padding with p″ instead of p′) in the input tensor and skipping insertion of rows and/or columns of zeros altogether, the compressed padding module 102 achieves minimal padding and thus eliminates most (if not all) multiplications by zero during the transposed convolution operation.

In the example of FIG. 1, the sub-kernel generation module 104 is configured to accept/take an original kernel k for the transposed convolution operation as input and divide the original kernel into a plurality of sub-kernels based on z number of rows and columns of zeros need/supposed to be inserted into the input tensor. Here, the original kernel k corresponds to one of a plurality of output channels for the transposed convolution operation. In some embodiments, the sub-kernel generation module 104 is configured to first calculate the maximum height and width of the plurality of sub-kernels as follows:

$$max\_sub \_kernel ( H ) = floor ( ( k ( H ) + z ( H ) ) / ( z ( H ) + 1 ) ) ; \\ max\_sub \_kernel ( W ) = floor ( ( k ( W ) + z ( W ) ) / ( z ( W ) + 1 ) ) ;$$

According to the equations above, the maximum height and width of the plurality of sub-kernels is less than the corresponding height and width of the original kernel k.

Once the maximum height and width of the plurality of sub-kernels have been calculated, the sub-kernel generation module 104 is then configured to compute numbers of the plurality of sub-kernels in both the height and width directions as well as the total number of sub-kernels based on the maximum height and width of the sub-kernels as follows:

$$num\_sub \_kernels ( H ) = z ( H ) + 1 ; \\ num\_sub \_kernels ( W ) = z ( W ) + 1 ; \\ total\_num \_sub \_kernels = num sub\_kernels ( H ) \cdot num sub\_kernels ( W ) .$$

For the non-limiting example discussed above, the number of sub-kernels can be computed from an original 6×6 kernel as follows according to the equations above:

$$max\_sub \_kernel ( H ) = floor ( ( k ( H ) + z ( H ) ) / ( z ( H ) + 1 ) ) = floor ( ( 6 / 1 ) / 2 ) = 3 ; \\ max\_sub \_kernel ( W ) = floor ( ( k ( W ) + z ( W ) ) / ( z ( W ) + 1 ) ) = floor ( ( 6 / 1 ) / 2 ) = 3 ; \\ num\_sub \_kernels ( H ) = z ( H ) + 1 = 1 + 1 = 2 ; \\ num\_sub \_kernels ( W ) = z ( W ) + 1 = 1 + 1 = 2 ; \\ num\_sub \_kernels = num\_sub \_kernels ( H ) \cdot num\_sub \_kernels ( W ) = 2 \cdot 2 = 4.$$

As a result, the original 6×6 kernel is divided into four sub-kernels—two in the height direction and two in the width direction, wherein the four sub-kernels can be denoted by sub-kernel(0, 0), sub-kernel(0, 1), sub-kernel(1, 0), and sub-kernel(1, 1), respectively, in a 2×2 sub-kernel matrix as shown by the example of FIG. 3D.

After the total number of the plurality of sub-kernels have been computed, the sub-kernel generation module 104 is configured to compute dimensions and layout (e.g., coefficient order) of each of the plurality of sub-kernels based on one or more of the number of the plurality of sub-kernels, the set of original padding parameters p′ (e.g., on the top, and left edges) and z number of rows columns of zeros need/supposed to be inserted into the input tensor. In some embodiments, the sub-kernel generation module 104 is configured to compute a vector of height indices in the y direction for each of the plurality of sub-kernels using one or more of the original padding number on the top edge, p′(top), the number of rows of zeros in the height direction, z(H), height of the original kernel k(H), and the maximum height of the sub-kernels, max_sub_kernel(H). In some embodiments, the sub-kernel generation module 104 is configured to compute a vector of width indices in the y direction for each of the plurality of sub-kernels using one or more of the original padding number on the left edge, p′(left), the number of rows of zeros in the width direction, z(W), width of the original kernel k(W), and the maximum width of the sub-kernels, max_sub_kernels(W). As a result, the sub-kernel generation module 104 computes a sub_kernels(H) vector of indices in the height direction and a sub_kernels(W) vector of indices in the width direction for the plurality of sub-kernels. Note that top and left padding parameters determine the coefficients within each vector.

For the non-limiting example discussed above, the sub_kernels(H) vector and the sub_kernels(W) vector of indices can be computed by the sub-kernel generation module 104 as follows:

$$sub\_kernels ( H ) = ( ( 1 , 3 , 5 ) , ( 0 , 2 , 4 ) ) ; \\ sub\_kernels ( W ) = ( ( 1 , 3 , 5 ) , ( 0 , 2 , 4 ) )$$

FIG. 3C depicts an example of a 6×6 original kernel k and FIG. 3D depicts examples of four sub-kernels generated from the original kernel k in the height and width directions, respectively based on the vectors of indices computed for the example above. As shown by the examples of FIGS. 3C and 3D, the original 6×6 kernel k is converted into four 3×3 sub-kernels—sub-kernel(0,0), sub-kernel(0,1), sub-kernel(1,0), and sub-kernel(1,1). Note that although the sub-kernels depicted in FIG. 3D are symmetric, the sub-kernels can also be asymmetric. For a non-limiting example, a 3×3 original kernel can possibly be converted to four sub-kernels with one or more of the following dimensions: 2×2, 2×1, 1×2, and 1×1.

In the example of FIG. 1, the direct convolution module 106 is configured to perform a plurality of direct sub-convolutions (i.e., convolution with a sub-kernel) by sequentially and directly applying each of the plurality of sub-kernels of the original kernel over the minimally-padded input tensor, wherein direct convolution or sub-convolution means applying the kernel or its sub-kernels on the input tensor without flattening either the input tensor or the plurality of sub-kernels into linearly-stored non-zero data first. In some embodiments, the direct convolution module 106 is configured to compute a pair of offset parameters, offset_x and offset_y in the width (x) and height (y) directions, respectively, for each of the plurality of sub-kernels, wherein the pair of offset parameters specifies the starting offsets in the input tensor for applying each of the plurality of sub-kernels for one of the direct sub-convolutions.

In some embodiments, the direct convolution module 106 is configured to compute the pair of offset parameters for each sub-kernel based on the original padding parameters p′ and z number of row and columns of zero need/supposed to be inserted as follows:

$$start\_idx ( H ) = {p}^{′} ( top ) \% ( z ( H ) + 1 ) ; \\ start\_idx ( W ) = {p}^{′} ( left ) \% ( z ( W ) + 1 ) ; \\ offset\_y ( subk\_idx ( H ) ) = subk\_idx ( H ) > start\_idx ( H ) ; \\ offset\_x ( subk\_idx ( W ) ) = start\_subk \_idx ( W ) > start\_idx ( W ) ;$$

where subk_idx(H) and subk_idx(H) are the sub-kernels' index in the height and width directions of the two-dimensional sub-kernel matrix, respectively. The notation “A>B” above is equivalent to “(A>B)?1:0”, meaning that if A is greater than B, return 1; otherwise, return 0. For the non-limiting example discussed above, where p′(top|left)=3 and z(H|W)=1, the offset_x and offset_y of the plurality of sub-kernels are computed as follows:

$$offset\_x ( 0 ) = 0 , offset\_x ( 1 ) = 0 , offset\_y ( 0 ) = 0 , offset\_y ( 1 ) = 0 ,$$

meaning that the starting offset of a direct sub-convolution for each of the sub-kernels in the 2×2 sub-kernel matrix is at offset (0, 0) of the input tensor.

FIG. 3E depicts an example of the first two steps of a convolution operation on the un-optimized/sparse input tensor padded under the original set of padding parameters p′ as shown in FIG. 3A in the width direction using the original kernel k of FIG. 3C with stride s′=1. In contrast, FIG. 3F depicts an example of the first two steps of a convolution operation on the optimized input tensor padded under the new set of padding parameters p″ as shown in FIG. 3B in the width direction using two different sub-kernels sub-kernel[0, 0] and sub-kernel[0, 1], respectively, as shown in FIG. 3D. Note that the sub-convolution steps are identical to the original convolution steps in the sense that the same kernel coefficients are used to multiply the same non-zero elements of the optimized input tensor as in un-optimized case, giving the same result. Furthermore, as shown in the case of convolution on the optimized input tensor of FIG. 3F, the starting offset for each sub-kernel is 0. Although the examples above only illustrate the convolution operation in the width direction, the same is true for the convolution operation in the height direction as well. Therefore, the starting offset for each sub-kernel is (0, 0). Note that in an alternative nonlimiting example where the original padding parameter p′ is 2 instead of 3, the sub-kernels would be used in reverse order and the starting offset for the second sub-kernel would be (1, 0).

In the example of FIG. 1, the output module 108 is configured to receive and combine outputs of each of the plurality of sub-convolutions by each of the plurality of sub-kernels to form a complete output tensor for the transposed convolution operation under the original kernel k, which corresponds to one of the plurality of output channels. In some embodiments, the output module 108 is configured to form the output tensor of the transposed convolution operation by interleaving the outputs from the plurality of sub-convolutions. In some embodiments, the output module 108 is configured to interleave the outputs from the plurality of sub-convolutions either on-the-fly or as a separate step at the end of receiving the outputs of the plurality of sub-convolutions.

In some embodiments, the sub-kernel generation module 104, the direct convolution module 106, and the output module 108 are configured to repeat the steps of dividing an original kernel into a plurality of sub-kernels, performing a plurality of direct sub-convolutions via the plurality of sub-kernels, and combining the outputs of the plurality of sub-convolutions, respectively, for each of a plurality of original kernels, wherein the plurality of original kernels correspond to a plurality of output channels for the transposed convolution operation. FIG. 3G depicts an example of combining outputs of a plurality of sub-convolutions of each of the plurality of output channels. As shown by the example of FIG. 3G, the outputs of the plurality of sub-convolutions of each sub-kernel group corresponding to an output channel N can be interleaved step-wise on a per-output channel basis by the sub-kernels as shown in FIG. 3D. In the example of FIG. 3G, kernel(0,0) and kernel(1,0) are used for even rows, and kernel(0,1) and kernel(1,1) are used for odd rows. As such by the example of FIG. 3G, the total output tensor size o(H, W, N)=(10, 42, 256) for 256 output channels, the same as the output tensor size for the transposed convolution operation based on unoptimized input tensor as discussed above. As such, the proposed approach achieves the same output for the transposed convolution operation while greatly reducing the number of zeros need to be multiplied during convolution.

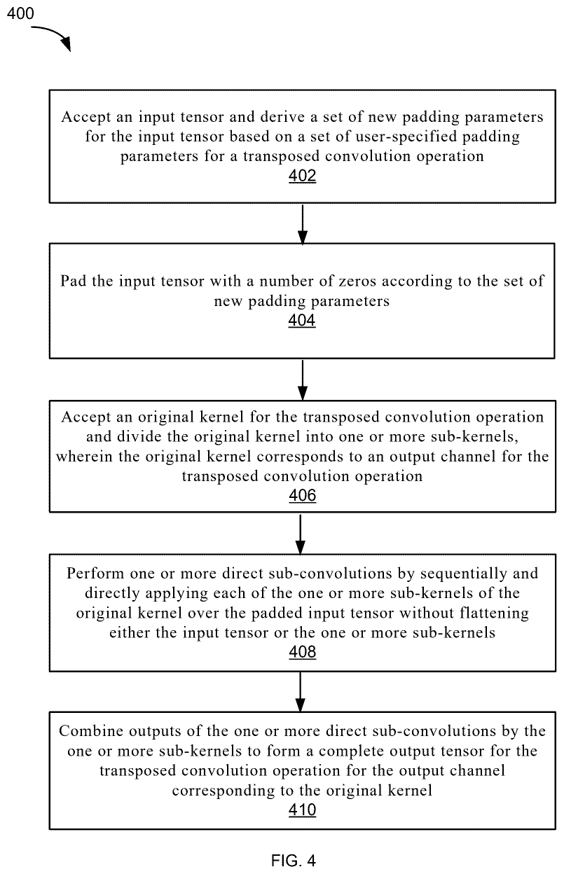

FIG. 4 depicts a flowchart 400 of an example of a process to support efficient implementation of transposed convolution. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402, where an input tensor is accepted and a set of new padding parameters for the input tensor is derived based on a set of user-specified padding parameters for a transposed convolution operation. The flowchart 400 continues to step 404, where the input tensor is padded with a number of zeros according to the set of new padding parameters. The flowchart 400 continues to step 406, where an original kernel for the transposed convolution operation is accepted and divided into one or more sub-kernels, wherein the original kernel corresponds to an output channel for the transposed convolution operation. The flowchart 400 continues to step 408, where one or more direct sub-convolutions are performed by sequentially and directly applying each of the one or more sub-kernels of the original kernel over the padded input tensor without flattening either the input tensor or the one or more sub-kernels. The flowchart 400 ends at step 410, where outputs of the one or more direct sub-convolutions by the one or more sub-kernels are combined to form a complete output tensor for the transposed convolution operation for the output channel corresponding to the original kernel.

FIG. 5 is a block diagram illustrating an example of a computing system/device 500 used to implement the system 100 to support efficient implementation of transposed convolution according to one aspect of the present embodiments. As discussed above, by reducing the number of zeros need to be inserted or padded into the input tensor for the transposed convolution operation and conducting direct convolution without flattening of either the input tensor and kernels first, the memory footprint for implementing the transposed convolution operation via the computing system/device 500 can be greatly reduced.

In the example of FIG. 5, the system 500 includes a processing unit 501, an interface bus 512, and an input/output (“IO”) unit 520. Processing unit 501 includes a processor 502, main memory 504, system bus 511, static memory device 506, bus control unit 505, and mass storage memory 508. Bus 511 is used to transmit information between various components and processor 502 for data processing. Processor 502 may be any of a wide variety of general-purpose processors, embedded processors, or microprocessors such as ARM® embedded processors, Intel® Core™2 Duo, Core™2 Quad, Xeon®, Pentium™ microprocessor, AMD® family processors, MIPS® embedded processors, or Power PC™ microprocessor. In some embodiments, the processor 502 may be a special-purpose accelerator, which can be but is not limited to a parallel processor.

Main memory 504, which may include multiple levels of cache memories, stores frequently used data and instructions. Main memory 504 may be RAM (random access memory), MRAM (magnetic RAM), or flash memory. Static memory 506 may be a ROM (read-only memory), which is coupled to bus 511, for storing static information and/or instructions. Bus control unit 505 is coupled to buses 511-512 and controls which component, such as main memory 504 or processor 502, can use the bus. Mass storage memory 508 may be a magnetic disk, solid-state drive (“SSD”), optical disk, hard disk drive, floppy disk, CD-ROM, and/or flash memories for storing large amounts of data.

I/O unit 520, in one example, includes a display 521, keyboard 522, cursor control device 523, decoder 524, and communication device 525. Display device 521 may be a liquid crystal device, flat panel monitor, cathode ray tube (“CRT”), touch-screen display, or other suitable display device. Display 521 projects or displays graphical images or windows. Keyboard 522 can be a conventional alphanumeric input device for communicating information between computer system 500 and computer operators. Another type of user input device is cursor control device 523, such as a mouse, touch mouse, trackball, or other type of cursor for communicating information between system 500 and users.

Communication device 525 is coupled to bus 512 for accessing information from remote computers or servers through wide-area network. Communication device 525 may include a modem, a router, or a network interface device, or other similar devices that facilitate communication between computer 500 and the network. In one aspect, communication device 525 is configured to perform wireless functions.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a compressed padding module configured to accept and pad an input tensor with a number of zeros according to a set of padding parameters for a transposed convolution operation;
a sub-kernel generation module configured to accept an original kernel for the transposed convolution operation and divide the original kernel into a plurality of sub-kernels, wherein the original kernel corresponds to an output channel for the transposed convolution operation;
a direct convolution module configured to perform a plurality of direct sub-convolutions by sequentially and directly applying each sub-kernel of the plurality of sub-kernels of the original kernel over the padded input tensor without flattening either the input tensor or the plurality of sub-kernels; and
an output module configured to combine outputs of the plurality of direct sub-convolutions by the plurality of sub-kernels to form a complete output tensor for the transposed convolution operation for the output channel corresponding to the original kernel.

2. The system of claim 1, wherein:
the sub-kernel generation module is configured to divide the original kernel into the plurality of sub-kernels based on numbers of rows and columns of zeros supposed to be inserted into the input tensor.

3. The system of claim 2, wherein:
the sub-kernel generation module is configured to calculate the maximum height and width of the plurality of sub-kernels based on size of the original kernel and the numbers of rows and columns of zeros supposed to be inserted into the input tensor.

4. The system of claim 2, wherein:
the sub-kernel generation module is configured to compute numbers of the plurality of sub-kernels in both height and width directions as well as total number of the plurality of sub-kernels based on the numbers of rows and columns of zeros supposed to be inserted into the input tensor.

5. The system of claim 4, wherein:
the sub-kernel generation module is configured to compute dimensions of each sub-kernel of the plurality of sub-kernels based on one or more of the number of the plurality of sub-kernels, the set of padding parameters, and the number of rows columns of zeros supposed to be inserted into the input tensor.

6. The system of claim 5, wherein:
dimensions of one or more of the plurality of sub-kernels are symmetric.

7. The system of claim 5, wherein:
dimensions of one or more of plurality of sub-kernels are asymmetric.

8. The system of claim 1, wherein:
the direct convolution module is configured to compute a pair of offset parameters, in width and height directions, respectively, for each sub-kernel of the plurality of sub-kernels, wherein the pair of offset parameters specifies starting offsets in the input tensor for applying each sub-kernel of the plurality of sub-kernels for one of the plurality of direct sub-convolutions.

9. The system of claim 1, wherein:
the output module is configured to form the complete output tensor of the transposed convolution operation by interleaving the outputs from the plurality of sub-convolutions.

10. The system of claim 9, wherein:
the output module is configured to interleave the outputs from the plurality of sub-convolutions on-the-fly.

11. The system of claim 9, wherein:
the output module is configured to interleave the outputs from the plurality of direct sub-convolutions as a separate step at end of receiving the outputs of the plurality of direct sub-convolutions.

12. The system of claim 1, wherein:
the sub-kernel generation module, the direct convolution module, and the output module are configured to repeat the steps of dividing each original kernel into a plurality of sub-kernels, performing a plurality of direct sub-convolutions via the plurality of sub-kernels, and combining the outputs of the plurality of sub-convolutions into an output tensor, respectively, for each of a plurality of original kernels corresponding to a plurality of output channels for the transposed convolution operation.

13. A method, comprising:
accepting and padding an input tensor with a number of zeros according to a set of padding parameters for a transposed convolution operation;
accepting an original kernel for the transposed convolution operation and dividing the original kernel into a plurality of sub-kernels, wherein the original kernel corresponds to an output channel for the transposed convolution operation;
performing a plurality of direct sub-convolutions by sequentially and directly applying each sub-kernel of the plurality of sub-kernels of the original kernel over the padded input tensor without flattening either the input tensor or the plurality of sub-kernels; and
combining outputs of the plurality of direct sub-convolutions by the plurality of sub-kernels to form a complete output tensor for the transposed convolution operation for the output channel corresponding to the original kernel.

14. The method of claim 13, further comprising:
dividing the original kernel into the plurality of sub-kernels based on numbers of rows and columns of zeros supposed to be inserted into the input tensor.

15. The method of claim 14, further comprising:
calculating the maximum height and width of the plurality of sub-kernels based on size of the original kernel and the numbers of rows and columns of zeros supposed to be inserted into the input tensor.

16. The method of claim 14, further comprising:
computing numbers of the plurality of sub-kernels in both height and width directions as well as total number of the plurality of sub-kernels based on the numbers of rows and columns of zeros supposed to be inserted into the input tensor.

17. The method of claim 16, further comprising:
computing dimensions of each sub-kernel of the plurality of sub-kernels based on one or more of the number of the plurality of sub-kernels, the set of padding parameters, and the number of rows columns of zeros supposed to be inserted into the input tensor.

18. The method of claim 13, further comprising:
computing a pair of offset parameters, in width and height directions, respectively, for each sub-kernel of the plurality of sub-kernels, wherein the pair of offset parameters specifies starting offsets in the input tensor for applying each sub-kernel of the plurality of sub-kernels for one of the plurality of direct sub-convolutions.

19. The method of claim 13, further comprising:
forming the complete output tensor of the transposed convolution operation by interleaving the outputs from the plurality of sub-convolutions.

20. The method of claim 19, further comprising:
interleaving the outputs from the plurality of sub-convolutions on-the-fly.

21. The method of claim 19, further comprising:
interleaving the outputs from the plurality of direct sub-convolutions as a separate step at end of receiving the outputs of the plurality of direct sub-convolutions.

22. The method of claim 13, further comprising:
repeating the steps of dividing each original kernel into a plurality of sub-kernels, performing a plurality of direct sub-convolutions via the plurality of sub-kernels, and combining the outputs of the plurality of sub-convolutions into an output tensor, respectively, for each of a plurality of original kernels corresponding to a plurality of output channels for the transposed convolution operation.

23. A system, comprising:
a means for accepting and padding an input tensor with a number of zeros according to a set of padding parameters for a transposed convolution operation;
a means for accepting an original kernel for the transposed convolution operation and dividing the original kernel into a plurality of sub-kernels, wherein the original kernel corresponds to an output channel for the transposed convolution operation;
a means for performing a plurality of direct sub-convolutions by sequentially and directly applying each sub-kernel of the plurality of sub-kernels of the original kernel over the padded input tensor without flattening either the input tensor or the plurality of sub-kernels; and
a means for combining outputs of the plurality of direct sub-convolutions by the plurality of sub-kernels to form a complete output tensor for the transposed convolution operation for the output channel corresponding to the original kernel.
